(19) United States
(12) Patent Application Publication
(10) Pub. No.: US 2002/0169935 A1
(43) Pub. Date: Nov. 14, 2002

(54) System of and method for memory arbitration using multiple queues

(76) Inventors: Robert F. Krick, Fort Collins, CO (US); David Jerome C. Johnson, Ft. Collins, CO (US); Paul L. Rogers, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/853,951

(22) Filed: May 10, 2001

(51) Int. Cl. G06F 12/00

(52) U.S. Cl. 711/167; 711/158; 711/105; 711/133

(57) ABSTRACT

The invention describes a system for and a method of using multiple queues to access memory entities. Priorities can be established between competing queues to allow maximum processing efficiency. Additionally, when more than one outstanding transaction affects the same memory location, dependencies are established to ensure the correct sequencing of the competing transactions.

### RELATED APPLICATIONS

The present application is related to concurrently filed, commonly assigned U.S. patent application Ser. No. [Attorney Docket No. 10004753-1], entitled “FAST PRIORITY DETERMINATION CIRCUIT WITH ROTATING PRIORITY,” the disclosure of which is hereby incorporated herein by reference.

### TECHNICAL FIELD

This invention relates generally to computer memory systems and more specifically to memory control within a system to improve access time to data using memory.

### BACKGROUND

It has become more desirable to increase the speed with which computers process information. One scheme for increasing processing speed includes improving memory access time.

A common manner in which to improve memory access time is to provide a cache memory along with a main memory. A cache memory is typically associated with a processor, and requires less access time than the main memory. Copies of data from reads and writes from the processor are retained in the cache. Some cache systems retain recent reads and writes, while others may have more complex algorithms to determine which data is retained in the cache memory. When a processor requests a data which is currently resident in the cache, only the cache memory is accessed. Since the cache memory requires less access time than the main memory, processing speed is improved. Today, memory accesses from the main memory may take as long as 250 nanoseconds while cache access may take two or three nanoseconds.

Additionally, a cache system may be used to increase the effective speed of a data write. For example, if a processor is to write to a storage location, the processor may perform a data write only to the cache memory. The cache memory and associated control logic may then write the data to the main memory while the processor proceeds with other tasks.

Computer systems may also extend the use of cache and may employ a multilevel hierarchy of cache memory, with relatively fast, expensive, limited-capacity memory at the highest level of the hierarchy and proceeding to relatively slower, lower cost, higher-capacity memory at the lowest level of the hierarchy. Typically, the hierarchy includes a small fast memory called a primary cache, either physically integrated within a processor integrated circuit or mounted physically close to the processor. Primary cache incorporated on the same chip as the Central Processing Unit (CPU) may have a frequency (i.e., access time) equal to the frequency of the CPU. There may be separate instruction primary cache and data primary cache. Primary caches typically maximize performance while sacrificing capacity so as to minimize data latency. In addition, primary cache typically provides high bandwidth. Secondary cache or tertiary cache may also be used and is typically located further from the processor. These secondary and tertiary caches provide a “backstop” to the primary cache and generally have larger capacity, higher latency, and lower bandwidth than primary cache. If a processor requests an item from a primary cache and the item is present in the primary cache, a cache “hit” results. While, if an item is not present, there is a primary cache “miss.” In the event of a primary cache miss, the requested item is retrieved from the next level of the cache memory or, if the requested item is not contained in cache memory, from the main memory.

Typically, all memories are organized into words (for example, 32 bits or 64 bits per word). The minimum amount of memory that can be transferred between a cache and a next lower level of the memory hierarchy is called a cache line, or sometimes a block. A cache line is typically multiple words (for example, 16 words per line). Memory may also be divided into pages (also called segments), with many lines per page. In some systems, page size may be variable.

Caches have been constructed using three principal architectures: direct-mapped, set-associative, and filly-associative. Details of the three cache types are described in the following prior art references, the contents of which are hereby incorporated by reference: De Blasi, “Computer Architecture,” ISBN 0-201-41603-4 (Addison-Wesley, 1990), pp. 273-291; Stone, “High Performance Computer Architecture,” ISBN 0-201-51377-3 (Addison-Wesley, 2d Ed. 1990), pp. 29-39; Tabak, “Advanced Microprocessors,” ISBN 0-07-062807-6 (McGraw-Hill, 1991) pp. 244-248.

With direct mapping, when a line is requested, only one line in the cache has matching index bits. Therefore, the data can be retrieved immediately and driven onto a data bus before the system determines whether the rest of the address matches. The data may or may not be valid, but in the usual case where it is valid, the data bits are available on a bus before the system confirms validity of the data.

With set-associative caches, it is not known which line corresponds to an address until the index address is computed and the tag address is read and compared. That is, in set-associative caches, the result of a tag comparison is used to select which line of data bits within a set of lines is presented to the processor.

A cache is said to be fully associative when a cache stores an entire line address along with the data and any line can be placed anywhere in the cache. However, for a large cache in which any line can be placed anywhere, substantial hardware is required to rapidly determine if and where an entry is in the cache. For large caches, a faster, space saving alternative is to use a subset of an address (called an index) to designate a line position within the cache, and then store the remaining set of more significant bits of each physical address (called a tag) along with the data. In a cache with indexing, an item with a particular address can be placed only within a set of cache lines designated by the index. If the cache is arranged so that the index for a given address maps to exactly one line in the subset, the cache is said to be direct mapped. If the index maps to more than one line in the subset, the cache is said to be set-associative. All or part of an address is hashed to provide a set index which partitions the address space into sets.

In all three types of caches, an input address is applied to comparison logic. Typically a subset of the address, called tag bits, are extracted from the input address and compared to tag bits of each cache entry. If the tag bits match, corresponding data is extracted from the cache.

In general, direct-mapped caches provide fastest access but requires the most time for comparing tag bits. Fully-associative caches have greater access time but consume higher power and require more complex circuitry.

When multiple processors with their own caches are included in a system, cache coherency protocols are used to maintain coherency between and among the caches. There are two classes of cache coherency protocols:

1. Directory based: The information about one block of physical memory is maintained in a single, common location. This information usually includes which cache(s) has a copy of the block and whether that copy is marked exclusive for future modification. An access to a particular block first queries the directory to see if the memory data is stale and the real data resides in some other cache (if at all). If it is, then the cache containing the modified block is forced to return its data to memory. Then the memory forwards the data to the new requester, updating the directory with the new location of that block. This protocol minimizes interbus module (or inter-cache) disturbance, but typically suffers from high latency and is expensive to build due to the large directory size required.

2. Snooping: Every cache that has a copy of the data from a block of physical memory also has a copy of the information about the data block. Each cache is typically located on a shared memory bus, and all cache controllers monitor or snoop on the bus to determine whether or not they have a copy of the shared block.

Snooping protocols are well suited for multiprocessor system architecture that use caches and shared memory because they operate in the context of the preexisting physical connection usually provided between the bus and the memory. Snooping is often preferred over directory protocols because the amount of coherency information is proportional to the number of blocks in a cache, rather than the number of blocks in main memory.

The coherency problem arises in a multiprocessor architecture when a processor must have exclusive access to write a block of memory or object, and/or must have the most recent copy when reading an object. A snooping protocol must locate all caches that share the object to be written. The consequences of a write to shared data are either to invalidate all other copies of the data, or to broadcast the write to all of the shared copies. Because of the use of write back caches, coherency protocols must also cause checks on all caches during memory reads to determine which processor has the most up to date copy of the information.

Data concerning information that is shared among the processors is added to status bits that are provided in a cache block to implement snooping protocols. This information is used when monitoring bus activities. On a read miss, all caches check to see if they have a copy of the requested block of information and take the appropriate action, such as supplying the information to the cache that missed. Similarly, on a write, all caches check to see if they have a copy of the data, and then act, for example by invalidating their copy of the data, or by changing their copy of the data to reflect the most recent value.

Snooping protocols are of two types:

Write invalidate: The writing processor causes all copies in other caches to be invalidated before changing its local copy. The processor is then free to update the data until such time as another processor asks for the data. The writing processor issues an invalidation signal over the bus, and all caches check to see if they have a copy of the data. If so, they must invalidate the block containing the data. This scheme allows multiple readers but only a single writer.

Write broadcast: Rather than invalidate every block that is shared, the writing processor broadcasts the new data over the bus. All copies are then updated with the new value. This scheme continuously broadcasts writes to shared data, while the write invalidate scheme discussed above deletes all other copies so that there is only one local copy for subsequent writes. Write broadcast protocols usually allow data to be tagged as shared (broadcast), or the data may be tagged as private (local). For further information on coherency, see J. Hennessy, D. Patterson, Computer Architecture: A Quantitative Approach, Morgan Kaufmann Publishers, Inc. (1990), the disclosure of which is hereby incorporated herein by reference.

In a snoopy coherence multiprocessor system architecture, each coherent transaction on the system bus is forwarded to each processor's cache subsystem to perform a coherency check. This check usually disturbs the processor's pipeline because the cache cannot be accessed by the processor while the coherency check is taking place.

In a traditional, single ported cache without duplicate cache tags, the processor pipeline is stalled on cache access instructions when the cache controller is busy processing cache coherency checks for other processors. For each snoop, the cache controller must first check the cache tags for the snoop address, and then modify the cache state if there is a hit. Allocating cache bandwidth for an atomic (unseparable) tag read and write (for possible modification) locks the cache from the processor longer than needed if the snoop does not require a tag write. For example, 80% to 90% of the cache queries are misses, i.e. a tag write is not required. In a multi-level cache hierarchy, many of these misses may be filtered if the inclusion property is obeyed. An inclusion property allows information to be stored in the highest level of cache concerning the contents of the lower cache levels.

The speed at which computers process information for many applications, can also be increased by increasing the size of the caches, especially the primary cache. As the size of the primary cache increases, main memory accesses are reduced and the overall processing speed increases. Similarly, as the size of the secondary cache increases, the main memory accesses are reduced and the overall processing speed is increased, though not as effectively as increasing the size of the primary cache.

Typically, in computer systems, primary caches, secondary caches and tertiary caches are implemented using Static Random Access Memory (SRAM). The use of SRAM allows reduced access time which increases the speed at which information can be processed. Dynamic Random Access Memory (DRAM) is typically used for the main memory as it is less expensive, requires less power, and provides greater storage densities.

Typically prior art computer systems also limited the number of outstanding transactions to the cache at a given time. If more than one transaction were received by a cache, the cache would process the requests serially. For instance, if two transactions were received by a cache, the first transaction request received would be processed first with the second transaction held until the first transaction was completed. Once the first transaction was completed the cache would process the second transaction request.

Numerous protocols exist which maintain cache coherency across multiple caches and main memory. One such protocol is called MESI. MESI protocol, which is described in detail in M. Papamarcos and J. Patel, “A Low Overhead Coherent Solution for Multiprocessors with Private Cache Memories,” in Proceedings of the 11^{th} International Symposium on Computer Architecture, IEEE, New York (1984), pp. 348-354, incorporated herein by reference in its entirety. MESI stands for Modified, Exclusive, Shared, Invalid. Under the MESI protocol, a cache line is categorized according to its use. A modified cache line indicates that the particular line has been written to by the cache that is the current owner of the line. An exclusive cache line indicates that a cache has exclusive ownership of the cache line, which will allow the cache controller to modify the cache line. A shared cache line indicates that one or more caches have ownership of the line. A shared cache line is considered read only and any device under the cache may read the line but is not permitted to write to the cache. An invalid cache line or a cache line with no owner identifies a cache line whose data may not be valid since the cache no longer owns the cache line.

### SUMMARY OF THE INVENTION

The invention includes a system and method of prioritizing, identifying and creating dependencies between outstanding transactional requests related to a secondary cache. Outstanding requests in read queues generally have priority over write requests, with the coherency queue having the highest priority. Additionally, when more than one transaction request affects the same memory location, a dependency is identified and created to ensure the first requested transaction which affected the memory location is processed first.

### BRIEF DESCRIPTION OF THE DRAWINGS

FIG. 1 shows secondary cache structure which includes two queues, a read queue and a write queue;

FIG. 2 shows a two dimensional array which represents the set associate cache contained in DRAM;

FIG. 3 is a secondary cache structure which includes a read queue, a write queue, a coherency queue, and an evict queue which are each used to read cache lines from the DRAM;

FIG. 4 shows the structure of the addresses for the various queues of FIG. 13;

FIG. 5 shows the structure of the addresses when transactions are pending in the coherency queue and the read queue;

FIG. 6 shows the structure of the addresses when transactions are pending in the read queue; evict queue, and write queue;

FIG. 7A shows the structure of the addresses when transactions are pending in the read queue and the write queue and the same memory portion of DRAM is affected;

FIG. 7B shows an example of a dependency selection when multiple address dependencies exist;

FIG. 7C shows an example of the wraparound nature of the queues; and

FIG. 8 is a chart illustrating the dependencies between the various queues.

### DETAILED DESCRIPTION

Generally, a memory hierarchy includes various components which operate at various speeds. These speeds may differ from the speed of the Central Processing Unit (CPU). Typically, as the distance from the CPU increases, the speed of the component decreases. These speed mismatches may be solved by queuing, or storing, the delayed operations. For example, Static Random Access Memory (SRAM) is used in cache operations and, Dynamic Random Access Memory (DRAM) technology has generally not been used for caches because it offers little benefit, in terms of access time, relative to the main memory. However, DRAM technology is approximately four times less expensive per bit of storage than SRAM and, because of its higher density, allows a much larger cache to be implemented for a given area. When “on package” real estate is critical, the density advantage of DRAM verses SRAM also becomes critical.

As the size of the SRAM implemented primary cache increases, the size of the memory required for the secondary or tertiary cache also increases. Typically when a cache hierarchy is implemented, the size of the memory at each succeeding level is increased by a factor of four or eight. Therefore, for a primary cache of one megabyte, a secondary cache of four to eight megabytes is desirable. As the size of the secondary cache increased, the use of SRAM became prohibitive because of its limited density. By using DRAM technology secondary caches of thirty two megabytes, or more, are possible. While time to access information stored in DRAM secondary cache increases, the overall affect is offset by the low primary cache miss rate associated with the larger primary cache. In other words, as the size of the primary cache increases, the secondary cache could include a longer latency.

To further reduce the latency associated with the secondary cache, the DRAM memory can be designed to include a faster access time. This faster access time is accomplished by using smaller DRAM chips than in main memory, increasing the number of pins used to transfer data to and from the DRAM, and increasing the frequency with which the DRAM chip operates. DRAM chips can be configured to allow a cache line to be transferred in the order of 15 nanoseconds.

Both the increased size of the secondary cache and its longer latency period (as compared to the primary cache) require a methodology to deal with multiple unfulfilled requests for data from the secondary cache. Requests may be received as fast as every two nanoseconds, and if it takes 15 nanoseconds for a request to be serviced, multiple additional requests may be received. While prior art systems have handled numerous requests to SRAM secondary cache sequentially, the use of larger DRAM secondary cache structures requires a more robust approach.

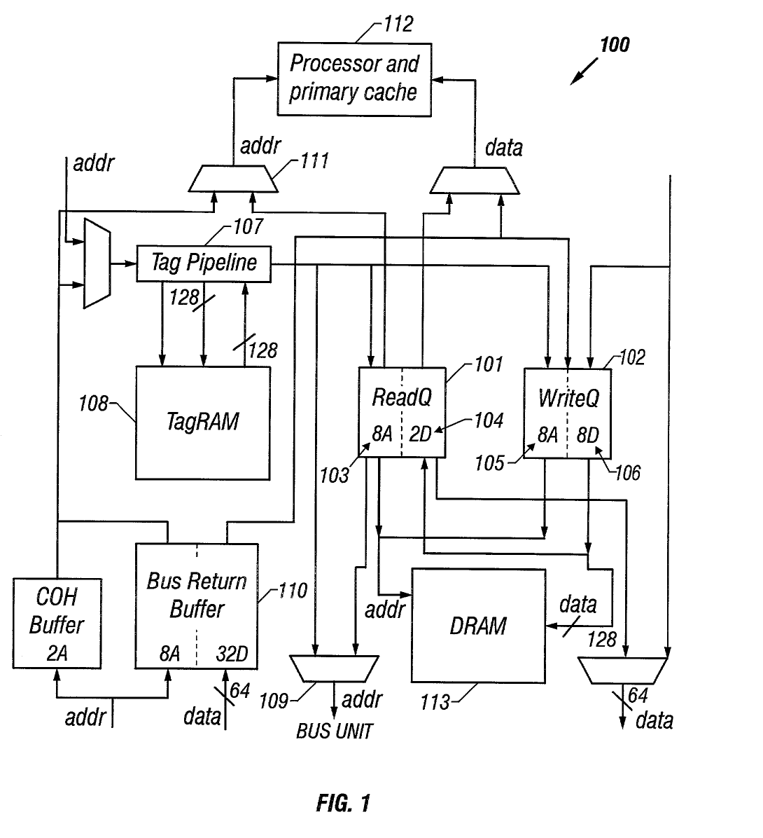

FIG. 1 shows secondary cache structure 100 which includes two queues, Read queue (ReadQ) 101 and Write queue (WriteQ) 102. For purpose of the present illustration, ReadQ 101 can hold eight addresses 103 and two lines of data 104 while WriteQ 102 can hold eight addresses 105 and eight lines of data 106. Address 103 and address 105 are buffered copies of the address of the cache line which will be stored in DRAM 113, not the cache line itself. When a read request is received by the secondary cache, it is processed by Tag Pipeline 107, which determines the location of the cache line in DRAM 113. The read request is stored in one of the address locations, and while the read is taking place, additional read requests can be received by ReadQ 101. Simultaneously, write requests can be received, processed by Tag Pipeline 107 and stored by WriteQ 102. The storage of multiple requests allows the caches to operate as non-blocking caches which allow the system to continue to operate with one or more unfulfilled transactions pending. A memory arbitrator, as described below, is used to determine the sequencing of multiple pending requests.

Tag Pipeline 107 and TagRAM 108 are used to determine whether the requested cache line is resident in the secondary cache. Tag Pipeline 107 is also operative to make room for a new cache line to be written into the secondary cache. If the cache line is resident in the secondary cache, the request is sent by Tag Pipeline 107 to ReadQ 101 which then acts on the request. ReadQ 101 then supplies the cache line to the CPU. If the cache line is not resident, the request is sent by Tag Pipeline 107 to main memory via Multiplexer 109. Cache lines returning from the main memory pass through Bus Return Buffer 110 and are sent via Multiplexer 111 to processor 112. These cache lines returning from main memory can also be stored in the secondary cache to reduce access time for subsequent retrievals of the same cache line. Tag Pipeline 107 and TagRAM 108 treat operations from the CPU atomically and sequentially. This hides the queuing behavior which is necessary to provide the data.

WriteQ 102 is responsible for writing new cache lines into the DRAM of the secondary cache. These cache lines are obtained from the processor or the main memory. The processor may send the cache line back to the secondary cache when it has updated the information contained in the cache line or the cache line may be sent to the secondary cache to remove the data from the primary cache. Cache lines coming from the primary cache are typically in the modified or “dirty” state. Storing the modified cache line in the secondary cache rather than the main memory allows a quicker subsequent retrieval of the cache line. Cache lines coming from the main memory pass through Bus Return Buffer 110, to WriteQ 102 and are stored in DRAM 113.

The size of DRAM 113 in a preferred embodiment is thirty-two megabytes. DRAM 113 can therefore store 262,144 cache lines where the size of each cache line is 128 bytes. In a preferred embodiment, DRAM 113 uses a four way set associate cache which contains 65,536 rows. The four way (0, 1, 2, 3) set associate cache therefore allows the storage of 262,144 cache lines. The set associate cache can be represented as a two dimensional array.

One of ordinary skill in the art would appreciate that, while the present description discusses a single processor requesting a cache line, the invention would be equally applicable to a number of processors which share the secondary cache.

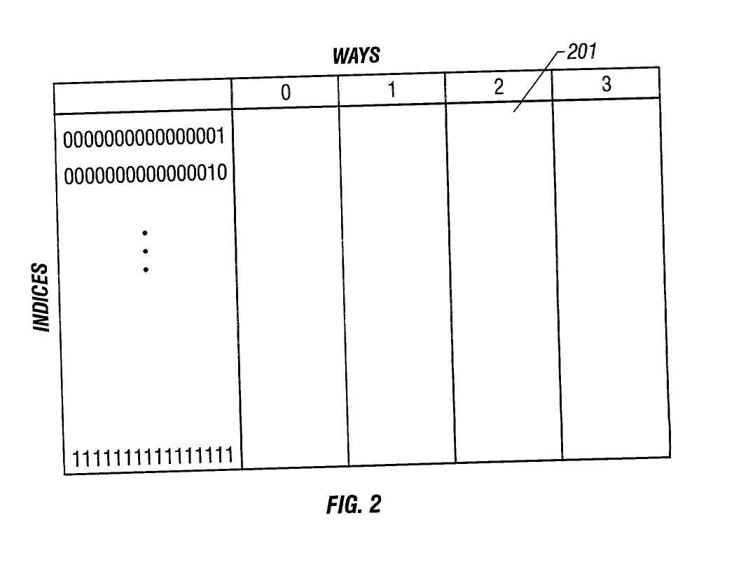

FIG. 2 shows a two dimensional array which represents the set associate cache contained in DRAM 113. The two dimensional array contains 65,536 indexes or rows and 4 ways (0, 1, 2, 3). When a cache line is sent to the secondary cache, Tag Pipeline 107 applies a function to the address to determine where in DRAM 113 the cache line should be stored. The function first determines which index the cache line should be stored in. Sixteen bits of the cache line address are used to determine the index. Next the cache line way is determined using the next two bits of the function. For example a cache line with the output of the function on the address 000000000000000110 would be stored in index 1 (0000000000000001) and way 2 (10). The cache line would be stored in space 201 of FIG. 2. Forty four bits are used in the main memory to address individual bytes where the upper 32 bits are used to differentiate the cache lines. Since only eighteen bits of the cache line address is used to determine where in DRAM 113 the cache line will be stored, more than one cache line may be stored in the same portion of DRAM 113, but preferably not simultaneously.

TagRAM 108 (FIG. 1) also contains 65,536 rows (indices) and 4 columns (ways) and is used to determine the location of a cache line in DRAM 113. When a request is received from the primary cache, Tag Pipeline 107 calculates an index used to access TagRAM 108. In a preferred embodiment, forty four bits (0 through 43) are used to address main memory, with 0 being the most significant bit and 43 being the least significant bit. Since cache lines contain 128 bytes the lower seven bits (37 through 43) are not used and can be dropped. Sixteen of the remaining bits (21 through 36) are used by Tag Pipeline 107 to calculate the index for both TagRAM 108 as well as DRAM 113. The remaining bits, bits 0 through 20, referred to as the “tag”, are stored in the appropriate portion of TagRAM 108. The bits stored in TagRAM 108, as well as the location as to where the bits are stored, are used by Tag Pipeline 107 to determine if the desired cache line is present in the secondary cache. In this embodiment, each of the four ways are checked to determine if the cache line is present in the secondary cache.

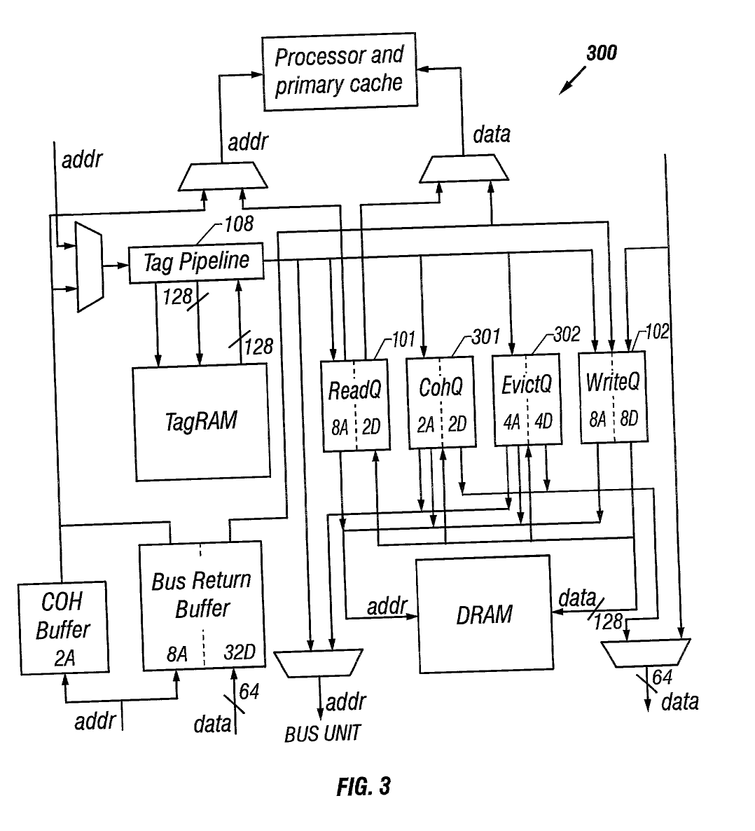

FIG. 3 is a secondary cache structure which includes ReadQ 101, WriteQ 102, Coherency queue (CohQ) 301 and Evict queue (EvictQ) 302. ReadQ 101, CohQ 301 and EvictQ 302 are each used to read cache lines from the DRAM. In FIG. 3, ReadQ 101 is used to read the cache line from the DRAM and return the cache line back to the processor. A copy of the cache line may be retained in the secondary cache.

CohQ 301 is used to read the DRAM and send the data to another processor via the external memory bus. CohQ 301 is used to satisfy a snoop from another processor. The snoop takes the cache line from the secondary cache and releases the cache line to a second processor in response to the snoop. CohQ 301 is similar to a remote read queue from a second processor.

EvictQ 302 clears a cache line from the DRAM. Depending on the state of the cache line, EvictQ 302 may discard the data (for shared or private clean data) or EvictQ 302 will return a dirty private cache line to the main memory or to a requesting processor. In either case, EvictQ 302 makes room in the secondary cache for subsequent data. Typically EvictQ 302 cooperates with Tag Pipeline 107 and TagRAM 108 to flush the oldest cache line from the secondary cache.

The system of FIG. 3 includes three separate specialized read queues in the form of ReadQ 101, CohQ 301, and EvictQ 302 because overall performance of the system is directly tied to the time required to service the reads from a processor. Both ReadQ 101 and CohQ 201 can, if the reads are not performed expediously, cause a processor to reduce its overall operating speed. EvictQ 302 is used to push old cache lines no longer needed back to main memory to allow for storage of additional cache lines. By devoting a separate queue to each of the reads, overall system performance is improved.

CohQ 301 of FIG. 3 can hold two addresses and two lines of data while EvictQ 302 can hold four addresses and can hold four lines of data. The number of addresses and the number of lines of data are a function of the performance desired from the secondary cache structure. As the number of addresses and the number of lines of data stored are increased, the overall performance of the system is increased.

The Queue architecture shown in FIG. 3 allows the incoming rate of transactions to temporarily exceed the rate at which the incoming transactions can be processed. In other words, there can be multiple requests outstanding at any given time. These outstanding requests are stored in the address queues of ReadQ 101, CohQ 301, EvictQ 302 and WriteQ 102. The separate distinct queues are used for the various transactions to give higher priority to more critical transactions. When multiple outstanding requests are present within a given queue, they are serviced in the order they were received. However, the outstanding requests within a given queue may not be serviced sequentially, as dependencies between queues may require an outstanding transaction in another queue to take priority over the servicing of the next outstanding request in the present queue. The dependencies are gathered within a dependency logic.

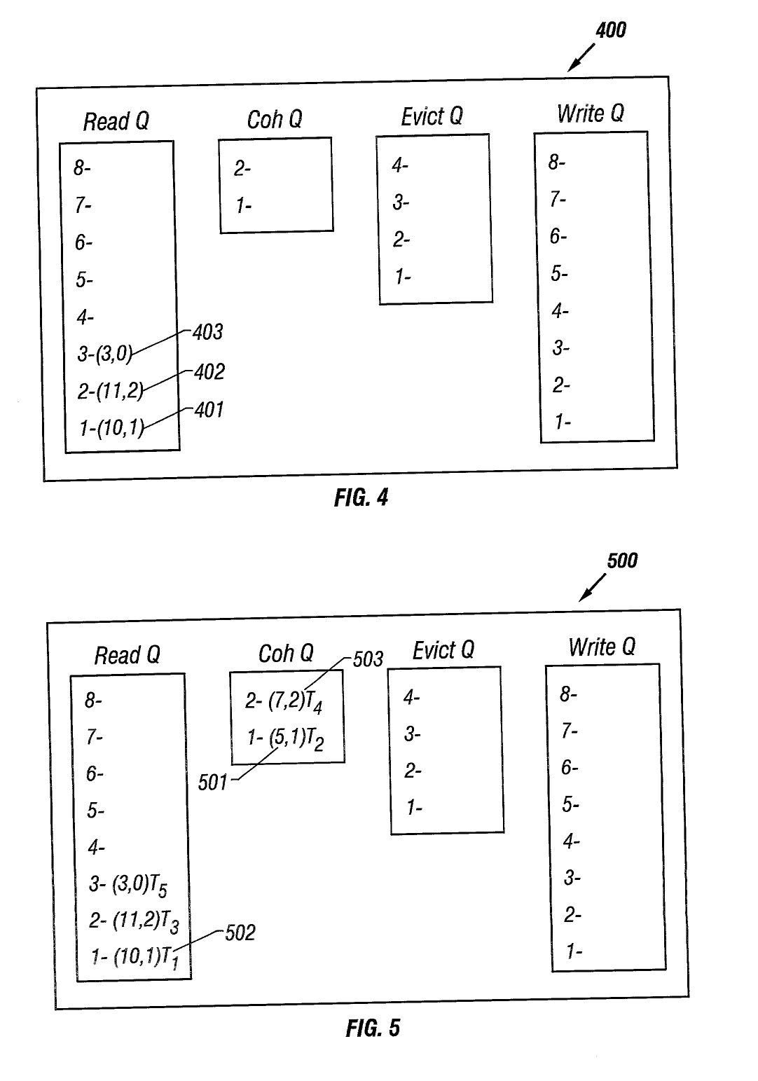

FIG. 4 shows the structure of the addresses for the various queues of FIG. 3. Addresses stored in the addresses of the various queues are with respect to DRAM 113 and not to the cache line address from main memory. As described in FIG. 2, a memory address in DRAM 113 is identified by an index and a way, in which the index varies from 0 to 65,536 and the way varies from 0 to 3. For the purposes of FIGS. 4 through 7 DRAM 113 memory address will be identified by ordered pairs of the form (x, y) where x represents the index value and y represents the way value. For instance (5, 3) would represent a cache line stored at an index value of 5 and way 3. As previously discussed, multiple outstanding requests present within a specific queue are processed in the order in which they were received. If a read for (10, 1) were received first, followed by read for (11, 2), followed by read for (3, 0), and each of the requests were outstanding, the ReadQ address 103 would appear as illustrated in FIG. 4. Without transactions pending in the other queues, read 401 would be serviced first, read 402 would be serviced next and finally read 403 would be processed last.

FIG. 5 shows the structure of the addresses when transactions are pending in the CohQ and the Read Q. The “T” designation indicates the time sequence at which the requests were received and processed by Tag Pipeline 107. In FIG. 5 at time T1 a read (10, 1) was received, followed by a Coherency (5, 1) at time T2, followed by a read (11, 2) at time T3, followed by a coherency (7,2) at time T4 followed by a read (3, 0) at time T5. Preferably, an outstanding coherency request takes priority over an outstanding request in any of the other three queues (ReadQ, EvictQ, or WriteQ). If each of the transactions identified in FIG. 5 were outstanding and have not begun, coherency (5, 1) 501 would be serviced before read (10, 1) 502 even though read (10, 1) 502 was received first. Additionally, since outstanding transactions in the coherency queue have priority over outstanding transactions in the other queues, outstanding coherency transaction (7, 2) 503 would also be serviced before read (10, 1) 502. Once each of the outstanding coherency transactions was serviced, the three outstanding read requests would be performed in sequence.

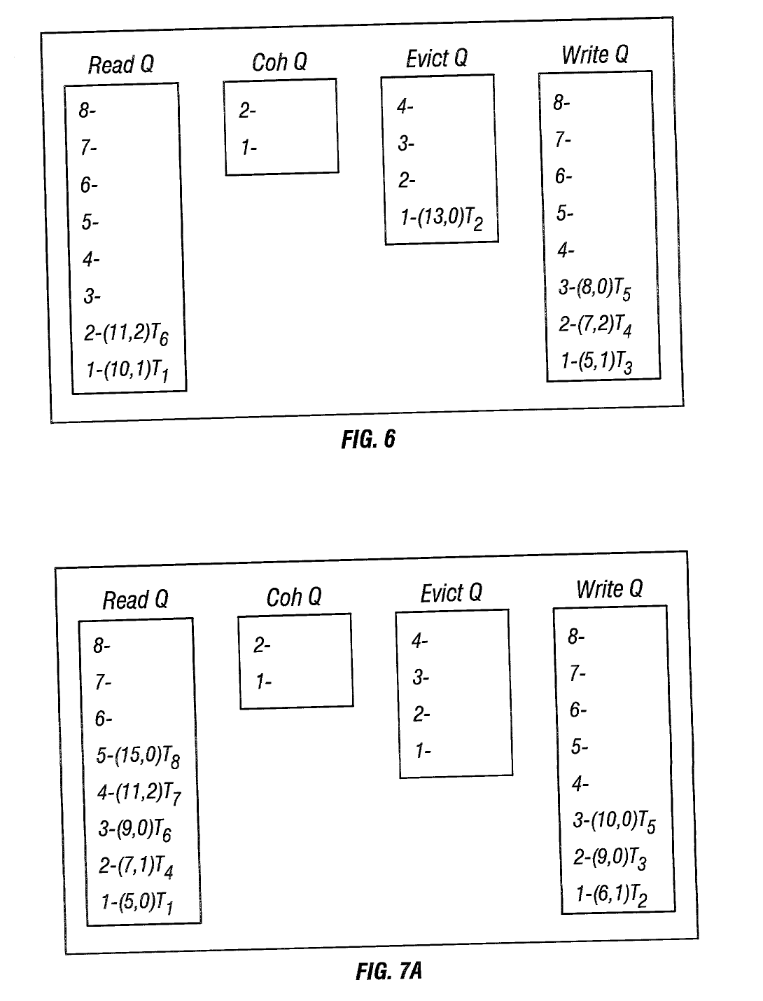

FIG. 6 shows the structure of the addresses when transactions are pending in the ReadQ, EvictQ and WriteQ. In FIG. 6 at time T1 a read (10, 1) was received, followed by an Evict (13, 0) at time T2, followed by write (5, 1) at time T3, followed by a write (7, 2) at time T4, followed by a write (8, 0) at time T5, followed by a read (11, 2) at time T6.

Preferably, barring action on the identical portion of DRAM 113, a read takes priority over a write. If each of the transactions identified in FIG. 6 were outstanding, read (10, 1) would occur first, followed by read (11, 2). Since Evict is a specific type of read, Evict (13, 0) would occur third followed by the three write requests in sequence.

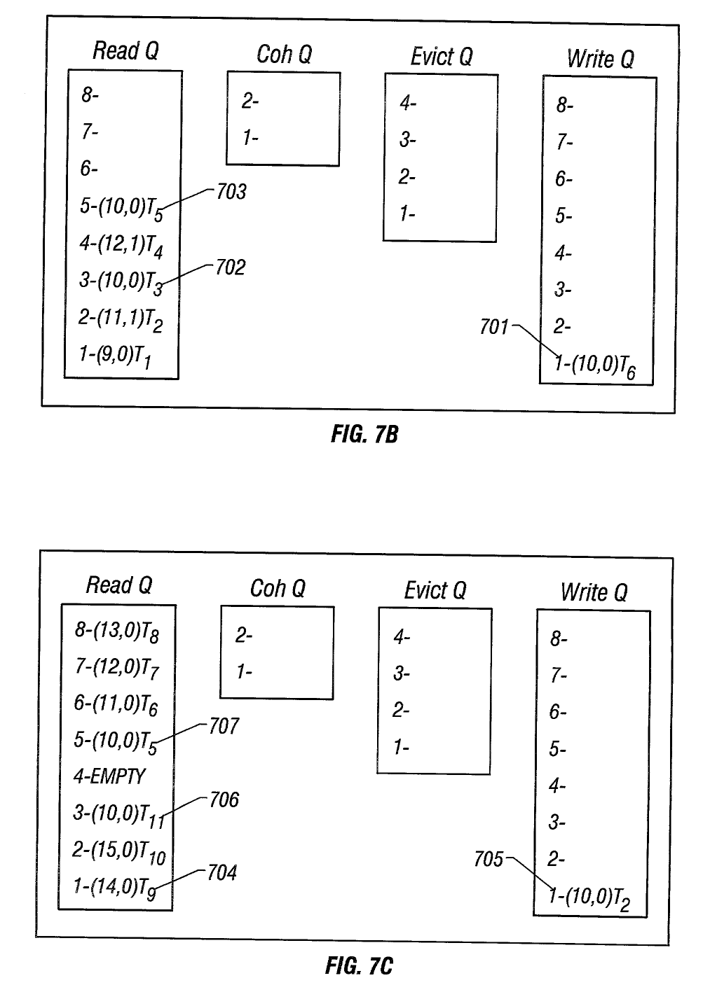

FIG. 7A shows the structure of the addresses when transactions are pending in the ReadQ and the WriteQ and the same memory portion of DRAM 113 is affected. In FIG. 7A at time T1 a read (5, 0) was received, followed by a write (6, 1) at time T2, followed by a write (9, 0) at time T3, followed by a read (7, 1) at time T4, followed by a write (10, 0) at time T5, read (9, 0) at time T6, followed by a read (11, 2) at time T7, followed by a read (15, 0) at time T8. As described with respect to FIG. 5, preferably, reads occur before writes as long as there is no conflict, i.e., the operations do not involve the same DRAM 113 memory location. However, when the same DRAM 113 memory location is affected, the operation which was requested first on that memory location must occur before the operation which was requested second is performed on that memory location. In other words, with respect to FIG. 7A, the write (9, 0) which occurred at time T3, must occur before the read (9, 0) which occurred at time T5 takes place. This sequencing is accomplished by checking for possible dependencies when a transaction is requested and, if a dependency is identified, ensuring the dependent transaction is accomplished prior to the transaction which caused the dependency.

At time T1 when the read (5, 0) was received, there were no outstanding transactions in any of the queues, so no dependency was identified. At time T2 when write (6, 1) was received, there were no other transactions which affected DRAM 113 memory location (6, 1) so no dependencies were identified. Similarly, at time T3 when write (9, 0) was received, each outstanding transaction was checked and no dependencies were identified because no outstanding transaction affected DRAM 113 memory location (9, 0). At time T4 read (7, 1) was received and again no dependency was identified. At time T5 write (10, 0) is requested, which again, does not conflict with any outstanding transactions. However, at time T6, when the request from Tag Pipeline 107 is checked for dependencies, the write (9, 0) will be identified and a dependency will be established which will require that the most recent entry in the write Q, which involves the dependency, will have to be completed before the read (9, 0) is serviced. In this example, read (5, 0) will be serviced first, followed by read (7, 1) followed by write (6, 1), followed by write (9, 0) followed by write (10, 0), followed by read (9, 0), followed by read (11, 2) followed by read (15, 0). By servicing the write (9, 0) before the read (9, 0) the system ensures the latest cache line for (9, 0) is being received by the read (9, 0) transaction.

FIG. 7B shows an example of dependency selection when multiple address dependencies exist. In this example, assume transactions T1, T2, T3, T4 and T5 are waiting in the read Q when at time T6, a write of (10, 0) is inserted in the write Q. When (10, 0) write 701 is inserted in the write Q slot 1, its address is compared against all the valid entries in the read Q. Slots 3 702 and 5 703 both match, so dependencies exist in that read Q slot 3 702 must execute before write Q slot 1 701, and read Q slot 5 703 must execute before write Q slot 1 701. However, the system does not need to keep track of both of these dependencies. It is sufficient to only record the dependency to the “youngest” read which is involved with the dependency, since there is an implicit priority within the read Q to always process the oldest transaction first. Read Q slot 3 702 must execute before read Q slot 5 703. Therefore, if write Q slot 1 701 only records a dependency to read Q slot 5 703 then the dependency on read Q slot 3 702 is implicitly satisfied.

FIG. 7C shows an example designed to highlight the rotating or wraparound nature of the Q structures and to show how dependency checking is impacted. For this example, assume that transactions at times T1, T2, T3, T4, T5, T6, T7 and T8 were all reads and were held in read Q slots 1-8 respectively. Then the transactions held in read Q slots 1-4 completed, and were removed from the read Q. The next read transaction will be placed in read Q slot 1 704, shown as (14, 0) T9. Note that the transaction T9 in slot 1 is still “younger” than the transactions in slots 5-8. Additional read requests T10 and T11 are then put in read Q slots 2 and 3. The slot where a new transaction is placed is controlled by the read Q insertion pointer. This is a rotating pointer in the sense that after inserting a transaction into slot 8, the pointer wraps around and points to slot 1 for the next insertion. As a result, the priority or “age” of a transaction is dependent both on its slot number and on the value of the read Q insertion pointer.

Continuing the example, a write to (10, 0) 705 arrives at time T12. When the write (10, 2) T12 is entered into the write Q slot 1 705, it's address is compared against the address of the read Q entries to find dependencies. In this case, slot 3 706 and slot 5 707 have address matches, so a dependency exists between read Q slot 3 706 and write Q slot 1 705, and a dependency exists between read Q slot 5 707 and write Q slot 1 705. Note that these are the same dependencies that existed in FIG. 7B, but because of the rotating nature of the read Q, the entry in slot 3 706 is now the youngest. So the entry in write Q slot 1 705 marks itself as dependent on read Q slot 3 706. The dependency on read Q slot 5 707 is implicitly handled by the fact that the read Q must execute its slot 5 707 before slot 3 706. One of ordinary skill in the art would understand the invention includes other combinations of address slots and numbering schemes.

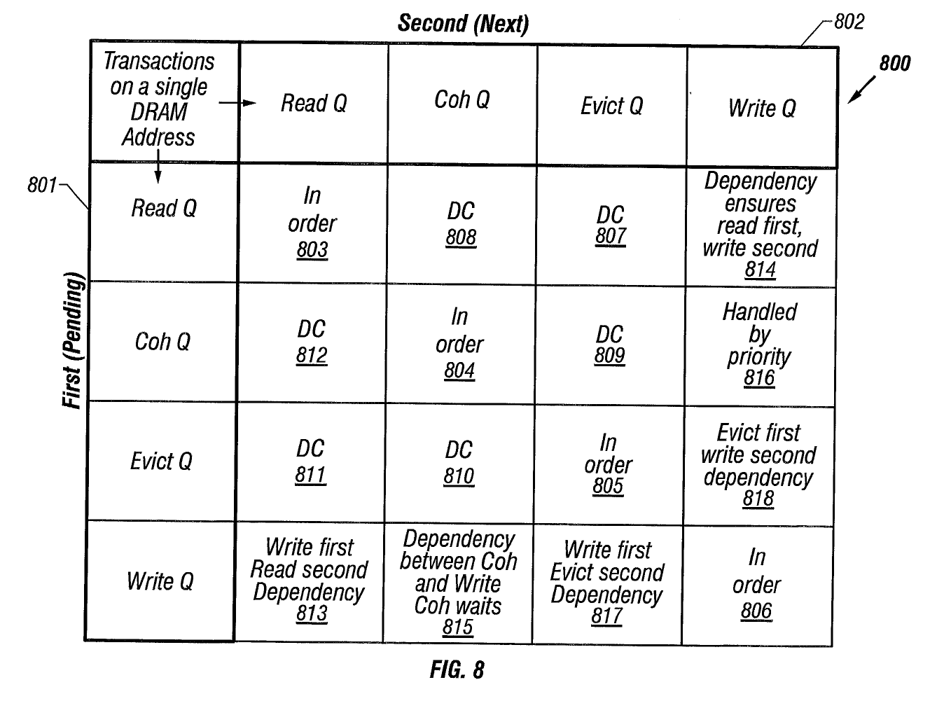

FIG. 8 is a chart showing the dependency logic priorities between the various queues. Column 801 identifies a queue which receives the first outstanding request. Row 802 identifies the queue which receives the second outstanding request for an operation or transaction on the same memory address. The contents of the table indicate the resulting dependencies. Diagonal cells 803, 804, 805 and 806 describe two outstanding transactions in the same queue. As previously described when two outstanding requests are contained in the same queue, the requested transactions are performed in the order in which received. Cells 807, 808, 809, 810, 811 and 812 are situations in which a first pending transaction involves a read and a second pending transaction also involves a read. Since reads are not destructive, these cells are labeled as don't cares (DC), i.e., the transactions may be conducted in any order. However, as previously described, an outstanding transaction in a coherency queue will always be serviced first through a priority and therefore a dependency is not necessary.

As illustrated in FIG. 8, cell 813 describes the dependency required when a write to a specific DRAM 113 memory location occurs before a read to the same DRAM 113 memory location. In this case, the write should occur prior to the read. The dependency is handled by ensuring that the most recent matching outstanding transaction in the write queue (when the read request was received) is serviced prior to servicing an outstanding entry in the read queue. Other dependency algorithms can be implemented similarly.

Cell 814 of FIG. 8 shows the reversed situation. Therein, a matching transaction to read a specific DRAM 113 memory address is received before an outstanding transaction to write to the same specific DRAM 113 memory address. In this case, a dependency is established which will ensure that the read occurs before the write. Preferably, the dependency is handled by ensuring that the most recent matching outstanding transaction in the read queue (when the write request was received) is serviced prior to servicing the outstanding entry in the write queue.

Cell 815 of FIG. 8 describes the dependency required when a write to a specific DRAM 113 memory location occurs before a coherency request to the same specific DRAM 113 memory location. In this case, the write should occur prior to the coherency. Preferably, the dependency is handled by ensuring that the most recent matching outstanding transaction in the write queue (when the coherency request was received) is serviced prior to servicing the outstanding entry in the coherency queue.

Cell 816 of FIG. 8 shows the reversed situation. In Cell 816, an outstanding coherency transaction for a specific DRAM 113 memory address is received before an outstanding transaction to write to the same specific DRAM 113 memory address. In this case, the priority which ensures that the coherency transaction will occur prior to the write transaction ensures the proper sequencing of the transactions.

Cell 817 of FIG. 8 describes the dependency required when a write to a specific DRAM 113 memory location occurs before an EvictQ request to the same specific DRAM 113 memory location. In this case, the write should occur prior to the evict. Preferably, the dependency is handled by ensuring that the most recent matching outstanding transaction in the write queue (when the evict request was received) is serviced prior to servicing the outstanding entry in the evict queue.

Cell 818 of FIG. 8 shows the reversed situation. In Cell 818, an outstanding evict transaction for a specific DRAM 113 memory address is received before an outstanding transaction to write to the same specific DRAM 113 memory address. In this case, the evict transaction should occur prior to the write transaction to ensure the cache line currently in the DRAM 113 location is not overwritten by the write transaction. The dependency is handled by ensuring that the most recent matching outstanding transaction in the evict queue (when the write request was received) is serviced prior to servicing the outstanding entry on the write queue.

What is claimed is:

1. A memory arbitrator comprising:
a read queue including a register for each entry to store addresses of respective pending read requests;
a write queue including a register for each entry to store addresses of pending write requests; and
a dependency logic to establish priorities of operations between said pending read queue and said pending write queue.

2. The memory arbitrator of claim 1 wherein:
said dependency logic prioritizes said pending read requests over said pending write requests.

3. The memory arbitrator of claim 1 wherein:
said dependency logic identifies pending read requests and pending write requests which affect a common memory location and wherein said dependency logic establishes a dependency relationship used for sequencing said pending requests affecting said common memory location.

4. The memory arbitrator of claim 3 wherein said memory location is a memory location of a DRAM.

5. The memory arbitrator of claim 3 wherein said memory location is a memory location of SRAM.

6. The memory arbitrator of claim 3 wherein said dependency favors an oldest pending request.

7. The memory arbitrator of claim 1 further configured to support operations of a cache memory including:
a coherency queue including a register for each entry to store addresses of respective pending coherency requests; and
an evict queue including a register for each entry to store addresses of respective pending evict requests;
wherein said dependency logic establishes priorities between said pending read requests, said pending write requests, said pending coherency requests and said pending evict requests.

8. The memory arbitrator of claim 7 wherein:
said dependency logic prioritizes said pending read requests over said pending write requests.

9. The memory arbitrator of claim 7 wherein:
said dependency logic identifies pending read requests and pending write requests which affect a common memory location and wherein said dependency logic establishes a dependency sequencing said pending requests affecting said common memory location.

10. The memory arbitrator of claim 9 wherein said memory location is a memory location of a DRAM.

11. The memory arbitrator of claim 9 wherein said memory location is a memory location of SRAM.

12. The memory arbitrator of claim 9 wherein said dependency favors a pending request.

13. A memory arbitrator comprising:
a read queue including a register for each entry to store addresses of respective pending read requests;
a write including a register for each entry to store addresses of respective pending write requests;
a coherency queue including a register for each entry to store addresses of respective pending coherency requests;
an evict queue including a register for each entry to store addresses of respective pending evict requests; and
a dependency logic configured to establish operational priorities between said pending read, write, coherency and evict requests.

14. The memory arbitrator of claim 13 wherein said dependency logic establishes dependencies between pending read, write, coherency and evict requests.

15. A method of controlling access to cache, said method comprising the steps of:
queuing pending read requests;
queuing pending write request; and
prioritizing an order of said pending read requests and said pending write requests.

16. The method of claim 15 wherein the step of prioritizing, prioritizes the read requests over the write requests.

17. The method of claim 15 further comprising a step of:
creating dependencies for pending requests which affect a common memory location.

18. The method of claim 15 wherein said step of creating dependencies prioritizes the first requested transaction over a later requested transaction.
